(19) United States
(12) Patent Application Publication
(10) Pub. No.: US 2019/0095862 A1
(43) Pub. Date: Mar. 28, 2019

(54) LOGISTIC CENTERS SUPPORTING FINAL MILE LOGISTICS / PACKAGE DELIVERY PROCESS AND APPARATUS FOR HANDLING ONLINE COMMERCE PACKAGES VIA AUTONOMOUS MOBILITY ENABLED BY ADVANCED TECHNOLOGY

(71) Applicant: AUTOBOTX, LLC, Rawlins, WY (US)

(72) Inventors: David Kilzer, Danville, CA (US); Craig Foster, Aptos, CA (US)

(73) Assignee: AUTOBOTX, LLC, Rawlins, WY (US)

(21) Appl. No.: 16/139,843

(22) Filed: Sep. 24, 2018

Related U.S. Application Data
(60) Provisional application No. 62/561,768, filed on Sep. 22, 2017.

(51) Int. Cl. G06Q 10/08; G05D 1/00

(52) U.S. Cl. CPC G06Q 10/08355; G05D 1/0088; G06Q 10/0837; G06Q 10/0836

(57) ABSTRACT

A Logistics Center for the processing and delivery is described. The Logistics Center and process provide customers with a plurality of delivery and/or retrieval options of a shipped package.

### RELATED APPLICATION

This application claims the benefit of US Provisional Patent Application No. 62/561,768, filed Sep. 22, 2017 and which is incorporated herein by reference.

### SUMMARY OF THE INVENTION

Unmanned parcel storage and retrieval centers (Logistics Centers, Centers) that will accept shipment parcels from traditional carrier methods and utilize multiple delivery mechanisms including air and surface autonomous vehicles, route autonomous vehicles, crowd-source transportation, in-person, personal proxy and others for delivery of these parcels to customers, businesses, and all other forms of entities that digitally procure products or services that produce packages (customers). These centers will also accept product return shipments from these customers. These activities are directed by customers through an app that puts them in control of where, how and when the deliveries are made and provides a consolidated view of and control over all the customer's inbound and return logistics and information.

### FIELD OF THE INVENTION

This invention relates to unmanned Logistics Centers, apparatuses, advanced technologies, network technologies, autonomous vehicles, autonomous mobility, customer facing technology including an APP, and the process for managing the logistics of customers, with all forms of electronic/digital (e-commerce) purchasing that creates all forms of commercial shipment (packages) for customers. The invention further relates that technology tools, apparatuses, network technologies and processes enabling the unmanned Logistics Center material handling equipment to manage large volumes of small to larger size shipment parcels and provides for environment control systems up to cold chain capabilities. The invention further relates that technology tools, apparatuses, network technologies, and processes including an App used by customers to control the outcomes of their logistics and delivery with focus on last mile (or final mile) delivery. The invention further creates the technology environment where deliveries to the customer can be to a traditionally defined physical address, or non-traditionally defined location using GPS coordinates or other non-ambiguous formats, and within a specified time interval. The invention further relates to an apparatus, technology and process incorporating multiple forms of autonomous vehicles, autonomous vehicles control systems, and autonomous vehicles operating systems necessary to operate from unmanned Logistics Centers for commercial transportation purposes including delivery to customers. This invention utilizes unmanned Logistic Centers which are domiciled in close proximity to the customers. The community, for this invention, is a particular area or place considered together with its inhabitants, that uses technology advances to improve lives.

As FIG. 8 illustrates, conventional delivery means (delivery van, package cars, trucks, et al.) must be selected during the purchasing activity as, once consigned to a carrier, the options are fixed. During the intervening time between order placement and delivery, the customer's schedule and needs often change. However, the existing delivery processes cannot react to such changes with required precision.

The invention allows the customer to receive consolidated (agnostic to carrier retailer) electronic delivery information as depicted in FIG. 9 and to be in control of the entire logistics process including the ability to select the final delivery method and timing for receiving the shipment package. This invention provides the customer accessibility, security, and convenience and puts autonomous vehicle delivery options in their hands and under their direction.

The invention incorporates the apparatus, technology and process that create the environment and ability for customers residing in communities to have access to autonomous vehicles operations. This autonomous vehicle platform supports delivery of shipments and pick-up of return product via multiple types of autonomous vehicles operating on the invention's autonomous technology integrated with the invention's single technology platform.

The customer is faced with an array of shipments, coming from various suppliers, being delivered by multiple carriers, highly varied sources of tracking information, multiple delivery schedules, differing service needs (e.g. refrigeration), and differing acceptance requirements. The invention's technology format and presents this data to the customer in a presentation that is easy to use, understand, and act upon. The inventions allows for a paradigm shift away from commercial shipping companies' terms of engagement or convenience to the purchasing customer's unique needs and schedules.

Additionally, this invention relates to online retailers that cannot maximize the E-commerce markets because customers are not satisfied with their contracted carriers' schedules, processes and procedures or alternative logistics options and companies' abilities to meet their requirement of flexibility and convenience. The customers' reality of inconvenience, inflexibility and unreliability of commercial shipping companies or new market entry logistics companies and any alternative they may offer, such as locker systems or drop points, are impediments to customer's full use of online shopping and therefore impede online retailer (online retailer includes online market place, internet, online pricing tool sites and any company trading electronically/digitally) companies' growth. As an example, packages which are “driver released” (left at the door step by the carrier) may then be exposed to the elements, damaged, or stolen by “porch pirates”, and therefore pose unacceptable risks for some customers.

The invention ties together, both physically and virtually, Logistic Centers and autonomous vehicles. Investment and design of autonomous vehicles for many purposes continue to grow but there has been limited investment in the infrastructure needed to support their commercial market use and practicality. This invention allows for a commercial use of autonomous vehicles and provides a physical and virtual platform for continued expansion of autonomous vehicles. The invention's Logistics Center has the technology tools, apparatuses, and technologies to load, unload, service and domicile autonomous vehicles without human interaction.

An important part of the invention is the creation of a new standard in logistics that domiciles the Logistics Centers within the communities they serve. For the purpose of this filing; the community for this invention is a particular area or place considered together with its inhabitants, using technology advances to improve lives. The Logistics Centers will be integrated into the fabric of the communities.

### BACKGROUND OF THE INVENTION

Customers are purchasing larger volumes of a broadening array of products from online retailers which require physical handling and delivery. The potential online retailer purchase sites for each of these products is vast. The growing use of online price comparison software tools that automatically search multiple different online stores to find the best price and delivery makes it more challenging for customers to clearly recall the online retailer where purchases were actually made. Each seller typically has unique agreements with commercial shipping companies. Commercial shipping companies such as UPS®, FedEx®, United States Postal Service (USPS) and DHL® have enormous resources directed under their term of engagement receiving, sorting, tracking, transporting, and delivering shipment packages to an intended customer. These carrier resources are organized for the efficiency and convenience of each shipping company and not specifically to the convenience of the customer.

Customers struggle with traditional modes of delivery when ordering online shipments of temperature sensitive products like food, wine, and medicines (as examples) as they are frequently damaged or ruined when they are released in locations or delivered to locations that do not meet their environmental requirements. Additionally, customers endure high levels of frustration with the current processes for returning packages (or returning of products) to the online retailers.

Currently, logistics process and schedules are dictated by the Carriers and the online retailers which fail to offer better options to meet the customers growing demand for on-demand convenient logistics and informational services. There is an unmet need for the customer to be able to control, when, how, and where they want their online purchases handled and delivered.

Accordingly, there remains a need for improvement within the art.

### SUMMARY OF THE INVENTION

The invention described herein is directed to both individual components and various combinations of components that work in tandem. These include Logistics Centers that are unmanned with internal handling apparatus, multi-modes of autonomous vehicle transportation, technology and network technology systems, specialty apparatuses, environmental storage up to cold-chain capabilities, and control tower and security.

The present invention including apparatuses and processes that resolves the challenges addressed in the background of this invention section above and gives the customer flexibility and convenience in managing their logistics and delivery of their online purchases (shipments/parcels). Information about all consigned customer packages and their associated logistics options are readily available via a single portal in the inventions' App, webpage and other customer facing technology tools. Logistics Centers hold and secure designated shipments (packages) until the customer is ready to receive them. Logistics Centers are located in close proximity to customers within the community and provide these customers a convenient means to receive their packages including the ability to provide autonomous on-demand delivery services. Multiple types of autonomous vehicles and other options from the Logistics Centers can be selected by the customer to best meet their needs and convenience. Operations are continuously open (24 by 7 by 365). This invention also provides an easy to use return process where receiving and returning packages can be done concurrently.

It is a further aspect of at least one embodiment of the present invention to provide a Logistics Center that uses robotics to create an unmanned operation. The Logistics Center comprises of a building that is of modular, easily assembled design. Each building will meet all building codes and tolerances required for its geographic location. The building has been designed operate with modular and easily assembled apparatuses including but not limited to: the cold-chain/over-sized package vault system, the induction machines, robotic storage/retrieval machines, package storage shelving system, specialty kiosks, disbursement/induction windows, automated loading apparatus for autonomous vehicles and other mechanical features. The building has also been designed to support a landing and take-off pad, exit and entry door for air and surface-based transportation robots, vehicles and drones and specialty door system for loading and unloading route autonomous vehicles. The building design includes capabilities for charging and maintaining all types of autonomous vehicles used in the applications of the Logistics Center. The building design includes drive-up service windows and walk-up service windows which are compliant with the American Disability Act. The Logistic Center is also climatically controlled via a heating and air-conditioning system and protected by a non-water-based fire suppression system. The building has been designed to provide a range of exterior facades in order to meet the specific aesthetics of each community in which they are integrated.

It is a further aspect of at least one embodiment of the present invention to provide a Logistic Center that is adapted for receiving shipments packages from online retailers, and product returns from the customers. The Logistic Center is equipped to receive shipment/packages from multiple traditional small package and other type transportation companies (carriers) and multiple autonomous vehicles.

It is one aspect of one of the present embodiments to provide for a Logistics Center that is a robotically operated. And located within the community close to the customers destination address or physical human location.

It is a further aspect of at least one embodiment of the present invention: to provide for a facility that can receive a commercial shipment package from a plurality of transportation companies and a plurality of different online retailer and store the shipments packages in a safe and environmentally appropriate set of conditions.

Its a further aspect of at least one embodiment of the present invention to provide for an induction machine that is used at the Logistic Center to intake the shipments packages. Through a connected system of multiple cameras, electronic scale, other electronic devices, material handling equipment and sophisticated software, the induction machine reads barcodes, acquires the weight of each package, captures electronic images, determines the length, width and height and evaluates the package for structural integrity.

It is a further aspect of at least one embodiment in the present invention that the information collected by the induction machine, including its height, width, length and weight and the digital images will be suitably archived. This information and data are made available electronically to the customer, package carrier and online retailer to verify the actual package parameters and condition when it was received and transferred to the customer to assist in resolution of claims for loss or damage, other challenges.

It is a further aspect of at least one embodiment of the present invention to provide for robotics and their control system in the Logistic Centers. These robots and their control systems do the physical put-a-way, picking, disbursement and re-slotting activity of shipment packages within the Logistic Center. These robots and their control system are unique as they are supported by and move along rails at the top of the storage rack versus a floor supported system enabling the system to be unaffected by deviations in floor flatness or other anomalies.

The robots and their control systems are designed to have multiple robots operating within the same Logistic Center working in unison and coordination. The robots and control systems are unique as multiple robots can operate in one compact oval track at a high rate of speed and package throughput.

It is a further aspect of at least one embodiment of the present invention to provide for specialty storage shelving systems that allow the storage of varied sizes of shipments and packages each of which use only the vertical storage height required for that unique package. This high-density storage system is created by a large number of available shelf elevations on small vertical increments. The invention will assign multiple vertical storage elevations to each package as required by the height of that unique package.

It is a further aspect of at least one embodiment of the present invention that the storage shelving system consists of six steel roll-formed uprights per section. Each roll-formed upright has multiple shaped notches arranged in small vertical increments which provide the shelf surface and which are formed during the roll forming process. Therefore, the shelf spacing has high inherent accuracy and there is no requirement for additional material or labor to create the shelf. The uprights are combined into an upright assembly by specially designed spacing components. The upright assemblies are further combined into a storage section by securing them to metal components separately attached to the floor and corresponding metal components at the top of the shelving section. The metal components at the top of the shelving section also secures the track that the top-hung robots travel on throughout the Logistic Center. The storage sections are further strengthened by the attachment of an “X” shaped wire rope assembly.

The storage methodology is completed by using metal sheets (or transportation sheets, storage medium) that rest on the “L” shaped notches of the roll-formed uprights. Integrated into the storage shelving system are the disbursement windows and the autonomous vehicle (Air and Surface) holding, handling, servicing and loading area and apparatus.

It is a further aspect of at least one embodiment of the present invention to provide for material handling and specialty robots that support the loading and unloading of autonomous type vehicles within the Logistics Center. Integrated into the storage shelving system are Autonomous vehicle (Air and Surface) holding, handling, servicing and loading apparatuses. These autonomous vehicles are loaded and unloaded by robots working in unison and coordination and within the same Logistics Center with the storage and retrieval robots.

It is a further aspect of at least one of embodiments of the present invention to provide a specialty-built vault system that is integrated (plug-in) into the design of a Logistics Center. The vault system has both cold-chain (refrigerated) units and large ambient vaults. The Logistics Center with the Robotic storage area and plug-in vault system is capable of handling a very large portion of the type and size of shipments packages that are typical of online shipments. The vault system can be configured according to customer specifications, including adding an extra column of locker(s) or adjusting locker sizes.

It is a further aspect of at least one of the embodiments of the present invention that the design of the Logistic Center includes the induction machine, the shelving system and the disbursement window will accommodate most common retail typical size packages.

It is a further aspect of at least one embodiment of the present invention to provide dispensary windows and a kiosk-based interface located at the facility with the capabilities to authenticate the individual, employ security protocols, and dispense the shipment package to the authorized individual.

a further aspect of at least one embodiment of the present invention to provide kiosk customer interfacing functionality on the customer's smart devices. It is a further aspect of at least one embodiment of the present invention that utilizes customer handheld smart devices to provide the capability to authenticate the customer/individual, employ security protocols, and enable dispensing the shipment package on the authorized individual.

It is a further aspect of at least one embodiment of the present invention to provide a set of customer-facing kiosks at each Logistic Center. The kiosk interfaces with and uses applications and data from proprietary systems to support the customer withdrawing their shipments at walk-up or drive-up service windows. The kiosks provide customer instructions on each step via a simulated chat feature. The Kiosk provides security features as it acquires digital images of the Kiosk user and can capture customer signatures with sign-on glass capability. The Kiosk also supports voice over Internet Protocol (VOIP) and a text-based chat feature with an off-site control tower and can optionally use facial recognition technology.

It is a further aspect of at least one embodiment of the present invention to provide for a proprietary system that interfaces with the customer and that will incorporate artificial intelligence. One aspect of the use of artificial intelligence will be cross selling of items the customer may want and improve the online buying experience of the customer. Another aspect of planned artificial intelligence will be the ability of the Company to personalize interactions with the customer.

It is a further aspect of at least one embodiment of the present invention to provide for apparatus and processes in which the Logistic Center can provide services for all type of air and surface robots, drones and vehicles for inbound and outbound shipment parcels. This include battery charging stations, automated battery exchange devices, landing/take-off pads, entry/exit doors, automated loading capabilities and access to revenue generating loads/shipments.

It is a further aspect of at least one embodiment of the present invention to provide for an apparatus and process in which the Logistic Center provides storage for robots and or drones. Storage could mean while the drone is not in use, waiting for the next mission, or longer-term storage if a drone isn't working properly and is waiting for a maintenance company to arrive.

It is a further aspect of at least one embodiment of the present invention to provide for an apparatus and process in which the Logistic Center provides the capability to upload data from Air and Surface robots, drones and vehicles to a proprietary cloud data management system. This data will be made available to the manufacturers of the vehicles as well as to the owner of the invention and other parties needing data for compliant Autonomous operations.

It is a further aspect of at least one embodiment of the present invention to provide for an infrastructure, process, technology platform and network technology platform which support operators of autonomous vehicles (Air and Surface) to deliver packages from a Logistic Center to the customer. The customer using the inventions and technology embodied herein can select a tailored delivery experience that include a chosen timeframe for delivery, the type of autonomous vehicle, a designated location, delivery to a person, and/or a technology-based coordinate/address.

It is a further aspect of at least one embodiment of the present invention to provide for technological coordination services between multiple autonomous vehicles operations and alternate crowdshare transportation companies, as a convenience option for the customer. The process of the current invention allows the necessary data and systematic protocol to be provided for the crowdshare transportation companies to access the kiosk or disbursement windows and the autonomous vehicle access/exit doors at the Logistic Center to pick up and subsequently deliver the shipment package to and at the direction of the customer.

It is a further aspect of at least one embodiment of the present invention to provide housing, servicing and maintenance of multi types of autonomous vehicles (Surface and Air) that are used to support the safety of the community These autonomous vehicles as example could provide civil defense, security, police, fire, and medical type services to the community. These emergency services will be provided on an as-required basis and could consist of reconnaissance air drones and other autonomous vehicles that can be dispatched by local fire and police agencies and by private security companies.

It is a further aspect of at least one embodiment of the present invention to provide the apparatus in which the Logistics Center provides storage of long-range Air Drones for use on demand.

It is a further aspect of at least one embodiment of the present invention that in the Logistic Center will provide housing, servicing and maintenance for human transportation vehicles (air and surface). With the incorporation of human autonomous transport vehicles into the Logistic Center, these vehicles would be used to transport heavy shipments packages to the Logistics Center for the community residents.

It is a further aspect of at least one embodiment of the present invention to provide for a pre-authorized family member or designated third-party to perform the self-pick up activity on behalf of the customer.

It is a further aspect of at least one embodiment of the present invention to provide for a cloud-based system which utilizes a combination of complementing systems including but not limited to: robotics control systems, kiosk systems, vault control systems, other third-party applications, specifically designed webpages, a autonomous vehicle platform and a full featured customer app and other customer facing technologies.

It is a further aspect of at least one embodiment of the present invention to provide an app, technology tools, and a process that will allow a customer to have deliveries sent to a physical address or to a person based on present physical location coordinates, or to other coordinate tools including those provided by traditional mapping techniques of longitude and latitude and non-traditional techniques.

It is a further aspect of at least one embodiment of the present invention to provide an app and website that provides customers with the necessary tools and visibility to oversee and control how they want their online purchase shipments handled.

It is a further aspect of at least one embodiment in the present invention to provide for electronic messaging via text, SMS, App, E-mail or other system with the customer at key milestones as their shipments' packages progress through each step of the customer order fulfillment process including receipt at the Logistic Center and to final delivery and/or pick-up.

It is a further aspect of at least one embodiment of the present invention to provide a “control tower” capability that provides real-time interaction with a human operator that can be accessed by the customer via an App, webpage, kiosks via chat feature, and when necessary voice communication (VOIP).

It is a further aspect of at least one embodiment of the present invention to provide for a “control tower” that electronically oversees the Logistic Centers. The control tower staff monitors the Logistic Centers using real-time video cameras and other technology to oversee all aspects of the Logistic Center operation and its users. Its charter includes the protection of customer, site and infrastructure support activities including but not limited to the dispatching of security, maintenance, repairs, management, customer care and others as required to address operational issues and needs.

It is a further aspect of at least one embodiment of the present invention to provide for a “control tower” that electronically oversees the activity of the autonomous vehicles and mobility operations. This includes ensuring autonomous operations work within standard operating procedures, meet key production indicators and maintain current approved operating status.

It is a further aspect of at least one embodiment of the present invention to provide for a “control tower” that electronically monitors autonomous and other delivery assets' adherence to local and federal law regarding the safe operation of such assets. This includes incorporating industry standard third-party services such as Unmanned Traffic Management (UTM) as provided by USS (UAS Service Suppliers) for Air Drones, and future industry standard services for ground based autonomous vehicles.

It is a further aspect of at least one embodiment of the present invention to provide for a Logistic Center adapted for security of users and packages, including monitoring of the Logistic Center interior and exterior on a real-time basis by the “control tower” and with a motion activated camera system that alerts the control tower staff when activated and takes and retain video as required.

It is a further aspect of at least one embodiment of the present invention to have online retailers incorporate the invention as an option on their normal webpage's customer checkout process. Based upon the customer's delivery address, the customer is provided Logistic Center options to enable self-customization of their logistics and delivery.

It is a further aspect of at least one embodiment of the present invention to give electronic tools to the customer which provide the ability to send their online shipment packages to the Logistics Center versus only to their home or business addresses.

It is a further aspect of at least one embodiment of the present invention to incorporate HTTP cookie (also called web cookie, internet cookie, browser cookie, or simply cookie) on the customer smart device with their consent in order to gain data to improve the experience of the end customer using the invention.

It is a further aspect of at least one embodiment of the present invention to give small package and other transportation carriers the electronic tools to use the Logistics Centers as drop-off points for their undeliverable shipment packages.

It is a further aspect of at least one embodiment of the present invention to provide electronic linkages via application, programming interface (API's) with transportation operators, using standard EDI (Electronic Data Interchange) protocols that collect data required to supply the customer real-time status of the packages that are inbound to the Logistics Centers and packages that have begun return transportation.

It is a further aspect of at least one embodiment of the present invention to provide connected technologies between autonomous vehicles (Air and Surface) operations and autonomous operating third-party software companies that have software necessary ensure a complete Deliver-EZ autonomous vehicle and mobility technology platform.

It is a further aspect of at least one embodiment of the present invention to provide software that may be utilized by the operators of all types of Autonomous vehicles, and which may be customized by third-party software developers for authorized participate in the package ordering and delivery process. The company will integrate each software component to create the necessary total software platform to operate legally and compliantly. This total autonomous vehicle and mobility platform is seamlessly linked and connected to the Logistics Center operations technology creating the Companies total operating technology platform.

It is a further aspect of at least one embodiment of the present invention to have a reservation, usage and scheduling system for autonomous vehicle usage.

It is a further aspect of at least one embodiment of the present invention to access the Global Positioning System tracking capabilities of the customer's smart device to proactively direct the robotics system to pre-position their packages in to hot zones within the Logistic Center to provide rapid delivery upon their arrival at the Logistic Center for self-pick up of online purchases.

It is a further aspect of at least one embodiment of the present invention to access the Global Positioning System tracking capabilities of the autonomous vehicles to provide rapid loading and unload activities at the Logistics Center and provide real-time tracking for the customers.

It is a further aspect of at least one embodiment of the present invention to provide a package storage management system that directs the robotic control to move packages to and from storage and delivery locations in a manner that provides rapid intake of packages, optimizes package storage capacity and provides rapid delivery of the packages to disbursement windows and to all types of autonomous vehicles loading material handling devices used in the operation.

It is a further aspect of a least one embodiment in the present invention to provide an apparatus, technology and a process to enable storage and delivery of shipments or packages that require adult verification of age and identity.

It is a further aspect of at least one embodiment of the present invention to provide technology and process of obtaining a signature of the person accepting the shipment packages when it is a requirement of the online retailer, carrier or as required by law.

It is a further aspect of at least one embodiment of the invention to have facial recognition software in support of properly identifying the customer when required.

It is a further aspect of at least one embodiment of the present invention to provide the process, communications technologies and network technologies that acquires all required data for each shipment package and ensures it is available before the package arrives at the Logistic Center. This process will include electronic assessment technology to ensure that package can be accepted legally, is compatible with the criteria set on products the Logistics Centers can handle, can be supported by the inventions logistics capabilities and can meet the customer's on-demand requirements.

It is a further aspect of at least one embodiment of the present invention to have a communication control device (tower) installed on or near the Logistics Center to communicate within a 3 to 5-mile radius to autonomous vehicles and other users of the Logistics Center.

It is a further aspect on at least one embodiment of the present invention that a storage medium metal sheet stacker and de-stacker has been designed and implemented in the invention. The stacker and de-stacker are used to make effective use of robot movements. The stacker and de-stacker position at the induction windows and disbursement doors allows a substantial number of metal sheets to be utilized and stored before Robots pick them up for traditional storage and waiting for reuse.

It is a further aspect of at least one embodiment of the present invention that the Logistic Center has safety system and emergency shut off that ensure the carrier representative and user of the center can not operate the center's tools, apparatus, machines etc. unless it is in a safe condition.

It is a further aspect of at least one embodiment of the presentation that the Logistic Center is conducive for introducing reusable/recyclable package programs between the online retailer, the carriers and the customer.

It is a further aspect on at least one embodiment of the present invention to provide a method and apparatus a method of facilitating the delivery of a package to a customer comprising the steps of:

providing a package receiving and holding facility;

providing secure access to a commercial shipper of customer packaging to the facility;

providing an intake control system wherein a customer package from the commercial facility is deposited, verified and stored, the storage step further including the step of a robotic transfer to a first storage location based on at least one of package size, pattern weight, package shape, and temperature storage needs;

following the storage step, providing an electronic notification to a customer that a package is available for pick up at the facility;

providing the customer with a plurality of pick up options including, but not limited to, self-pick up, designated friend/family member, courier service delivery, delivery by air drone, delivery by surface robot, delivery by autonomous vehicle or delivery by a designated authorized agent who may retrieve and deliver the package.

It is a further aspect on at least one embodiment of the present invention to provide a process of delivering a package to a customer comprising the steps of:

providing a customer at a point of purchase a delivery option for a final mile service delivery;

verifying customer information and customer packaging requirements that an address and package content may be processed via the last mile delivery service provider;

accepting shipment from a retailer to a final mile logistic center;

accepting receipt of the package at a final mile logistic center, the acceptance process further including accessing a secure logistic center building by a carrier deliverer using a security protocol and further including granting access to carrier personnel to the logistic center, the access in including interaction with an induction apparatus;

placing the package on an induction sheet associated with the induction apparatus, the induction apparatus providing the functions of scanning the package bar code, calculating the package weight, determining dimensions of length, width, height, and shape of the package, taking visual images of five sides of the package to determine package integrity, and storing the package information obtained within a database of the logistics center operator;

moving the induction sheet and package placed upon the induction sheet to a storage location within a logistic center;

delivering an electronic communication from the logistics curter to the customer that the package is available for delivery;

prompting the customer to select a package delivery option selected from the group consisting of self pick up, pick up via an approved individual on a list of approved individuals; home delivery via a third party; surface transportation robot, air drone service, autonomous vehicle, and

providing access to the packaging based upon the delivery option requested by the customer.

It is a further aspect on at least one embodiment of the present invention to provide a process as described above wherein when the package pick-up option includes a manual, in person pick-up, an individual retrieving the package is prompted to activate a GPS device;

tracking the GPS device, dispatching the package to a designated retrieval location when the GPS indicates the agent has arrived at the logistic center;

directing the individual to a specific kiosk and a distribution window;

validating that the package is within the disbursement window, the package being dispatched to the disbursement window via a robotic retrieval process.

These and other features, aspects, and advantages of the present invention will become better understood with reference to the following description and appended claims.

### BRIEF DESCRIPTION OF THE DRAWINGS

A fully enabling disclosure of the present invention, including the best mode thereof to one of ordinary skill in the art, is set forth more particularly in the remainder of the specification, including reference to the accompanying drawings. The Figures set forth details of Logistics Center that is unmanned and robotically operated with links to a connected autonomous vehicle and mobility platform that gives the customer, via the inventions APP and customer facing technology tools, control of the logistics and the delivery process including but not limited to; purchase by retailer, shipment details, logistics information including but not limited to: receiving, storing, delivery of packages, returns, and handling special circumstances.

FIG. 1 is a perspective view of a Logistics Center in accordance with the present invention.

FIG. 2 is a perspective view of a package induction area in accordance with the present invention.

FIG. 3A is a perspective view of a metal tray associated with a package induction area in accordance with the present invention.

FIG. 3B is a perspective view of a metal tray having a package thereon which is placed in an inventory storage area.

FIG. 4 is a perspective view of a metal tray being positioned within a support rack using an automated robotic system.

FIG. 5 is a perspective view similar to FIG. 1, showing additional details of a drone deployment area of a Logistic Center.

FIG. 6 is a perspective view of a package delivery drone within a Logistics Center depicting a process where packages can be delivered to the drone.

FIG. 7 is a view in partial section illustrating the delivery of a package from the Logistic Center to an interior of an autonomous vehicle.

FIG. 8 illustrates prior art delivery steps and processes.

FIG. 9 illustrates delivery steps and processes of the present invention.

### DESCRIPTION OF THE PREFERRED EMBODIMENT

Reference will now be made in detail to the embodiments of the invention, one or more examples of which are set forth below. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used on another embodiment to yield a still further embodiment. Thus, it is intended that the present invention cover such modifications and variations as come within the scope of the appended claims and their equivalents. Other objects, features, and aspects of the present invention are disclosed in the following detailed description. It is to be understood by one of ordinary skill in the art that the present discussion is a description of exemplary embodiments only and is not intended as limiting the broader aspects of the present invention, which broader aspects are embodied in the exemplary constructions.

In describing the various figures herein, the same reference numbers are used throughout to describe the same material, apparatus, or process pathway. To avoid redundancy, detailed descriptions of much of the apparatus once described in relation to a figure is not repeated in the descriptions of subsequent figures, although such apparatus or process is labeled with the same reference numbers.

As used herein, the term “customer” may include a retail customer who has ordered a package, or an agent/designee/or recipient other than the original customer.

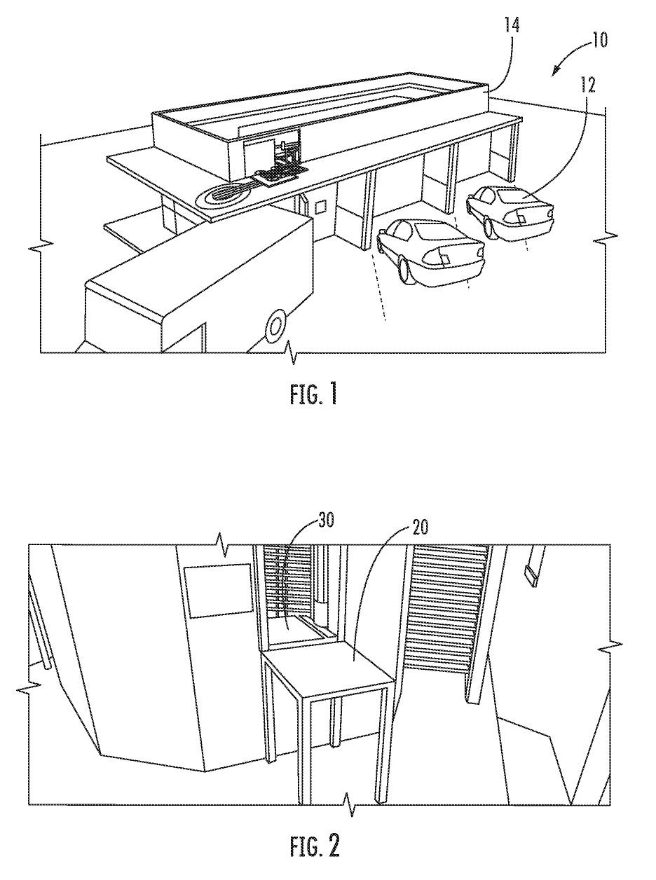

Set forth in FIG. 1 is a perspective view of a Logistics Center 10 and which may be linked and connected to multiple types of passenger operated and autonomous vehicles 12 and mobility platform 14 for delivery drones but controlled by one business operation system incorporating a complete autonomous mobility system. The facility has a ground level electronically controlled man-access door that allows assigned carriers' drivers, or other mode of transportation companies' drivers, and maintenance and repair personal limited access into the Logistic Center. This access is controlled by using a kiosk through which one wishing to gain access initiates a protocol which ensures the access request is valid and appropriate before granting access. Access can be by scanning an anticipated carrier tracking number, or by entering a known return goods authorization number, or through a coding system for maintenance and repair providers or by “control tower” direction for police and fire department entry.

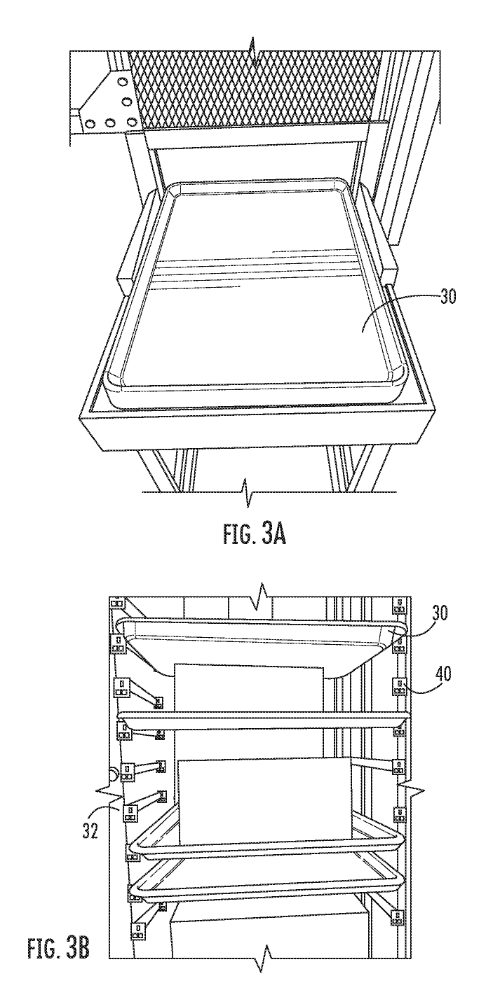

Following approved access to the facility, the driver enters the carrier access doors into an unload area (FIG. 2) that provides an induction area 20 for receiving and processing a package. The driver's access is restricted to the unload area as all other areas and parts of the Logistics Center are protected by additional barriers to ensure the driver cannot enter into to the robotic storage operating areas. The driver performs a protocol function on the induction kiosk directly next to the induction machine. The driver unloads the shipment packages, places them one by one onto a metal transportation sheet or tray 30 (see FIG. 3A & 38). As the robotic machine is removing the packages from the induction window, induction cameras, and weight scales system will acquire images of all visible sides of the package and measure the package's weight. The induction machine will use these images to measure the package dimensions (length, width and height) and decode identifying barcoded information. This information is transmitted to the cloud-based system which verifies that the package is expected at the Logistic Center and that all required Delivery information is in the associated shipment record. This data, including the package dimensions, weight, identifying bar coded data and images is transmitted to the cloud-based system which creates and stores the receipt record.

If the package does not meet all necessary criteria, the system will refuse to accept it and will return the package to the carrier via the robotic system. If the package requires cold storage it will be assigned a cold storage vault and returned to the carrier with the instructions to place it in an assigned vault. If the package is too large for robotic storage it will be assigned an oversize vault and returned to the carrier with the instructions to place it in an assigned vault.

Once the verification conditions and steps are met successfully, the cloud-based technology will select the optimum storage location for the package based upon its size, available inventory of unoccupied storage locations, likelihood for imminent delivery to the customer and other criteria. Dependent upon size a package may consume multiple storage locations vertically.

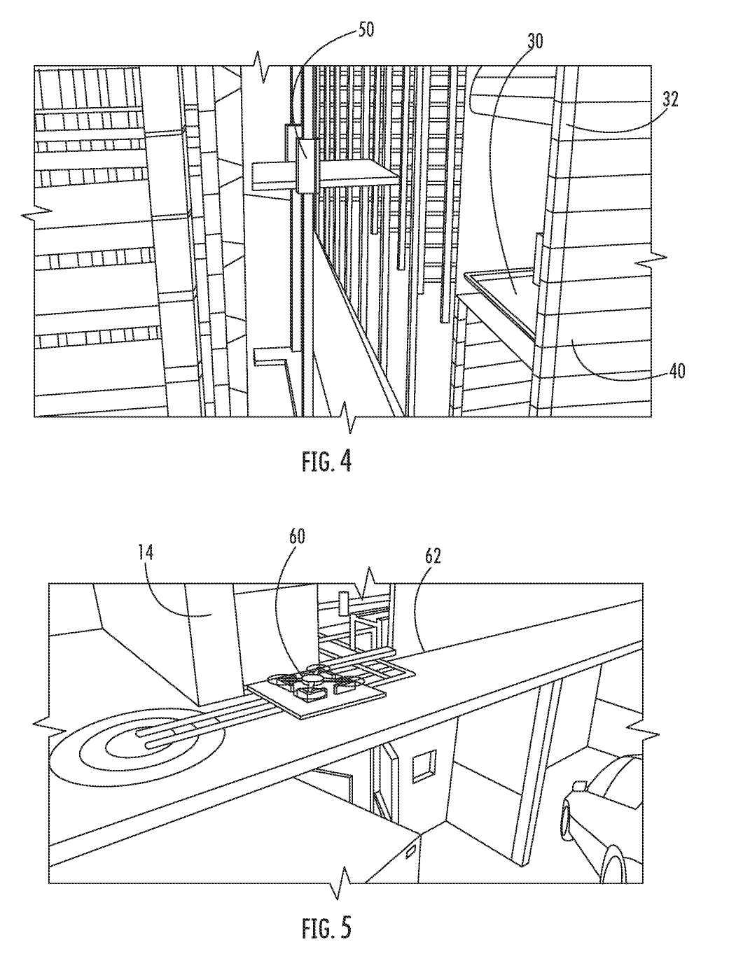

The cloud-based system will provide the movement instructions to the robotic control system which will select and dispatch a robot 50 to move the package from the induction machine to the selected storage location. (FIG. 4) In one embodiment of the invention, the robot can include a handling system that moves the metal tray with the package situated thereon unto one of multiple of slotted shelf-like receiving areas 40 which will retain the metal tray and the package. The metal tray, and the associated retaining shelf 32 with a plurality of tray receiving positions, will accommodate packages of various height and allows the exact coordinates and positioning of the stored package to be known later for retrieval. As needed, the position of a package and metal tray can be moved to provide for additional stored items, the moved location of the metal tray and package being updated within the storage software programming used to coordinate the automated handling and movement of the induction trays and packages.

For efficiency, the delivery driver will be informed via the cloud-based system at the time of first registration to enter the Logistics Center that he/she has a cold-chain or oversized packages to be processed. These packages' special requirements will have been pre-identified with the exchange of package data between the online retailer, the inbound carrier, and the invention's cloud-based technology. When the carrier arrives at the Logistics Center with the packages which require unique cold chain or over-sized storage locations, the driver is directed to the Kiosk that supports the integrated vault system where pre-assigned vault has designated for handling the special requirement shipment/package.

The invention is also designed to move packages to and from storage locations to Autonomous vehicle loading stations for those packages that have been selected for Autonomous delivery. As shown in FIGS. 5 and 6 on the second level of the Logistics Center there is a landing take-off pad 60 for Air drones. In one embodiment, the drone landing take-off pad 60 is placed on a movable platform 62 that can position the landing take off pad for safe operation and then can move the pad with the drone secured to it via a transport rail and automatic door into the interior of the facility. Inside the Logistic Center, there is an automated handing system designed to facilitate the drone's acquisition and subsequent loading of the package (FIG. 6). The facility also has an area that is designed for the automated servicing of a drone with battery recharging, battery swap, and holding area. This part of the invention can be accurately characterized as an “Air drone airport”. The drones themselves may be owned by the Logistic Center operator, or owned and operated by third party firms which are responsible for all aspects of their flight operations. The invention enables customers to use the invention's app or webpage to book transportation shipments via multi modes of autonomus vehicles.

Additionally, on the second level of the Logistics Center there are storage location(s) for Air Drone(s) used for specialty purposes like civil defense, medical, security, police and fire.

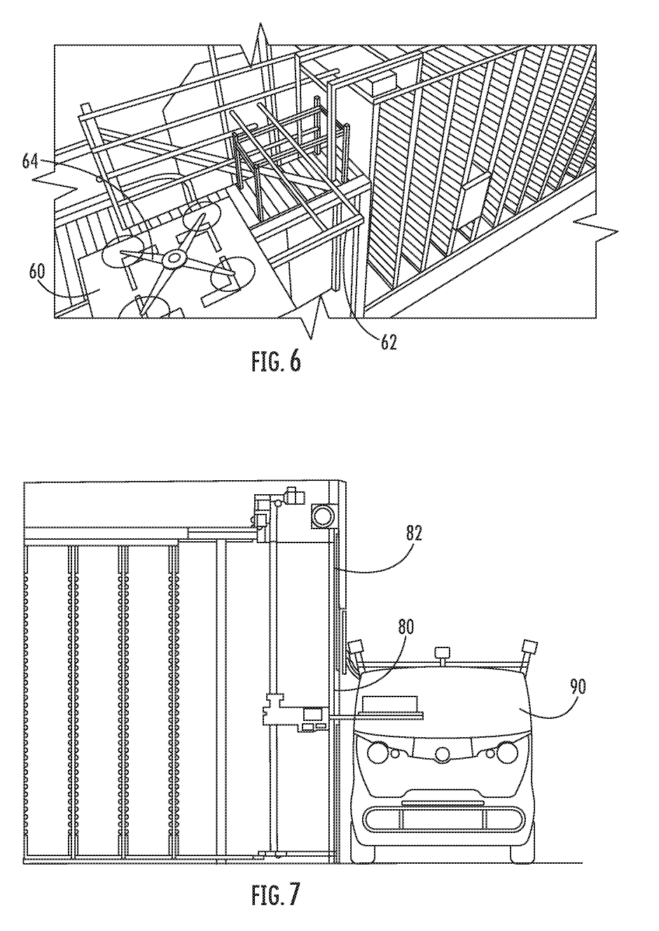

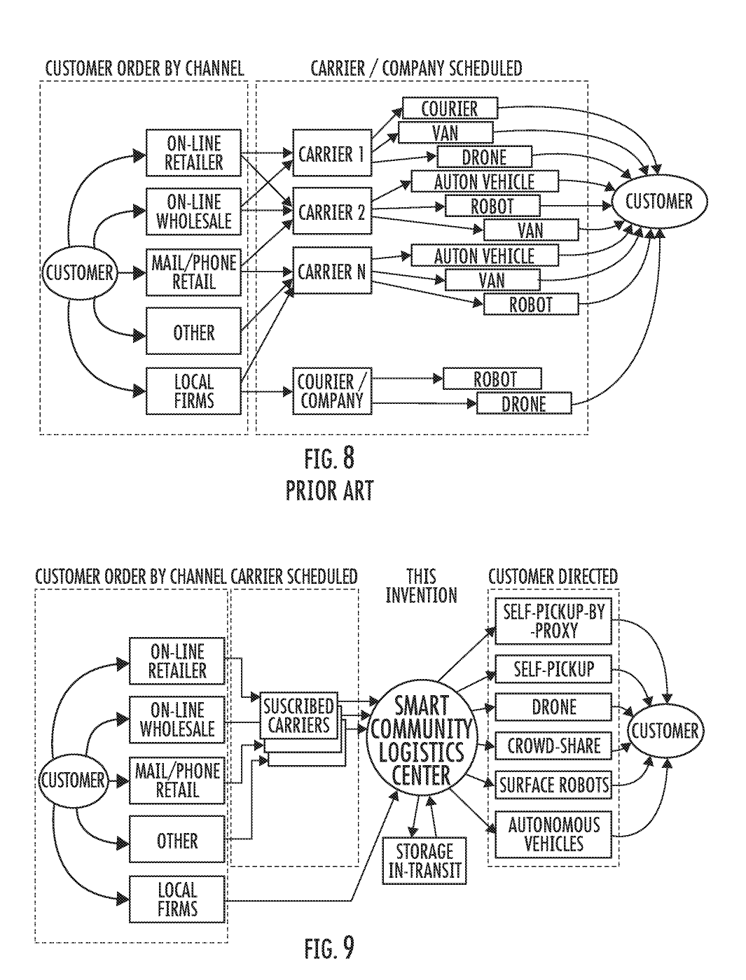

The invention is also designed to move packages that have been selected for autonomous vehicle delivery from storage locations to route autonomous vehicles' loading stations where the packages are loaded into the route autonomous vehicle. As shown in FIG. 7, this loading area 80 is incorporated into the Logistics Center. The loading process can be accomplished by the robots as employed in the storage area. In one embodiment, the route autonomous driverless vehicle loading area has a door system, such as a roll-up door 82, which supports the loading of the vehicles while ensuring the site remains secure by creating an opening that only facilitates loading a specific compartment on the autonomous vehicle 90. In other words, the dimensions of the cargo door that opens on the route autonomous vehicle has a profile such that it fits substantially flush with the loading area with the Logistics Center. As such, an unauthorized user or other individual can not gain entry to either of the open cargo door or to the Logistics Center because of the narrow gap margins provided between the building and route autonomous vehicle. The invention's capability is not restricted to a specific autonomous vehicle design or company. The invention enables customers to use the invention's app or webpage to book transportation shipments via ail forms of autonomous vehicles.

The invention employs robotic automated materials handling equipment to move packages from the induction location to storage locations, between storage locations and between a storage location and disbursement windows, from disbursement windows to induction station and storage locations (returns) and from storage location to induction station (returns).

Packages are delivered upon request of a customer at a Kiosk to a disbursement window (walk-up and drive-up applications). Each disbursement window is located adjacent to a customer facing customer kiosk. A customer uses the invention's app to display the provided Quick Response codes (bar code) which is scanned by the kiosk. Alternately the encoded data may be entered manually or transmitted via near-field-communications (NFC) or other means. The entry of this data, after validation by the cloud-based system, initiates the retrieval process. The cloud-based technology system instructs the robots' control system to dispatch a robotic machine to move a package from a storage location to a disbursement window. Once the disbursement window apparatus detects the presence of the package it closes an internal door assuring the customer cannot reach into the robotics operating zone, moves the package near the disbursement window and signals the customer the disbursement window's door is unlocked and can be opened. The door is then opened and the package is retrieved. Once the customer has retrieved their shipment and closed the disbursement window, the disbursement window's door is locked, the interior door is opened, and the emptied tray stored by the stacker/un-stacker device. The robotic system removes the emptied metal transport sheet when the number of sheets reaches a pre-determined number in the stacker/un-stacker apparatus and the disbursement window is ready for the next package withdrawal.

Packages that have been evaluated as eligible for delivery by surface-based transportation robots will be identified as such to the customer. The customer can elect to use this delivery method using the invention's app or website. The surface-based robots themselves can be owned/leased by the Logistic Center operator or are owned and operated by third party firms who are responsible for all aspects of their operations.

When a customer selects a surface-based transportation robot delivery method the invention's cloud-based technology will mediate between the customer and the surface delivery robot company and the company's autonomous mobility software platform facilitating the scheduling, booking and operation of this service. The technology platform will instruct a surface delivery robot to move into the loading position within the Logistics Center

The invention will dispatch a robot to retrieve the package and move it to the loading position where another robot will remove the package from the metal transportation tray and place it into the surface-based robot. The surface-based robot will move to the access door where the door will then open. The surface-based robot will exit the facility and travel to the destination location for delivery of the shipment package. After completion of the delivery the surfaced based robot will return to the Logistics Center where the invention will cause the door to open and it will become available for the next delivery. Once the robot is inside the invention, data will be transmitted to invention's cloud technology and used for analytics purposes.

The Logistic Center may have several kiosks to accommodate multiple customers and carrier activities simultaneously. These kiosks provide the interface between the customer and carrier representatives and the invention's cloud-based technology. The invention makes novel use of the combination of kiosk and a smart phone, providing the customer multiple ways to direct the invention to deliver shipments/packages and perform pre-approved product returns. The primary features of the kiosk for customer's usage include: providing smart phone interface, enabling chat with the off-shore control tower, providing step by step process on using the invention by words and videos, supporting sign-on glass, capturing images of the user as point of verification, and supporting ADA requirements. In the future, the Kiosk will support Near Field Communication activities and taking electronic payments.

To achieve a more rapid delivery of their package after their arrival at the invention, the customer can permit the app to monitor their physical location through their phone's GPS. This data will predict their arrival time at the invention facility. The invention will cause the robot to move their package(s) adjacent the disbursement window (Hot zones) prior to their arrival reducing the time taken to retrieve and deliver their package(s).

The invention as described provides the customer multiple ways to acquire their package(s). These include multiple autonomous vehicle types, crowdshare transportation companies and self-pick-up. As a variation to self-pick-up, the invention's website and/or app also provides the customer the ability to create a pre-approved list of individuals referred to as “Friends and Family”. The customer can then assign the credentials necessary to have their shipment package pick up performed by a member of their Friends and Family list.

This invention also provides customers the ability to return purchases/products pre-approved and suitably labeled packages to the package's original supplier. At one of the inventions kiosks, the customer will be instructed to scan the pre-approved returns label on the package. Once verifying the status of the package as a pre-approved return the invention's cloud-based system will direct the robot to move an empty metal transportation tray into the disbursement window and close the interior door. The customer will be instructed to open the disbursement door, place the subject package on the metal transport tray and close the door.

Once the disbursement door is closed, the automation will reopen the interior door. A robot will move the package to the induction machine. At this point it will be photographed on all visible sides, and measured and weighed. The package will then be moved into a storage location awaiting the next visit by the assigned return carrier. When the carrier arrives, they will be informed of the pending return(s). At the first opportunity the package will be moved to the induction workstation where the carrier will retrieve the return.

The present invention lends itself to a number of process and method steps. The process steps below can be combined in various combinations to accommodate any special requests. The process steps in Table below may include in various combinations:

TABLE 1

| Step | Normal Process Description (without exceptions) |
|---|---|
| 1 | Customer makes decision to purchase products with and on an |
| | Online retailer/website |
| 2 | Customer at check-out from the Online retailer Place |
| | website selects a delivery transit level from the Online |
| | retailer plus the use of Logistics Center (LC) for |
| | logistics or |
| | Customer, registered with Logistic Center, |
| | uses their normal assigned location |
| | address as the destination of their online purchase or |
| | Transitional Small package carriers (under agreement |
| | with Logistics Center operator) offer LC as a service |
| | offering to their customers or the online |
| | purchasing is done via the app that supports the |
| | customer to use the LC operation(s) |
| 3 | Online retailer/Carrier/or L.C. App working in |
| | concert provides electronic (EDI) information (via API's) |
| | of the Customers contact information, the |
| | purchase information and normal required shipment |
| | information, including but not limited to: |
| | Online retailer's information |
| | Customers contact details |
| | Name |
| | Address |
| | Zip Code |
| | Email address |
| | Smart phone numbers |
| | General information about the shipment |
| | Shipment number |
| | Product classifications |
| | Additional requirements |
| | Adult shipment verification process |
| | Signature required |
| | Shipment cold-chain requirements |
| 4 | LC operator receives the information about the customers |
| | purchase and vets if LC can accept the shipment. |
| | LC accept or |
| | LC communicates back to the retailer, carrier or |
| | customer that it cannot accept. |
| 5 | LC accepts the shipment and creates the shipment record |
| | in its cloud-based technology |
| 6 | LC sends a first electronic note to the Customer |
| | that a shipment from the said online retailer is being |
| | processed and will be sent to Deliver-EZ. |
| 7 | The Online retailer processes the shipment in their |
| | Distribution or place of fulfillment center/organization |
| | for pick, pack and snip operations, including |
| | election/selection of assigned carrier. |
| 8 | Online retailer sends a second electronic |
| | record to LC operator with complete |
| | shipment information, including but not limited to: |
| | Repeat of customer name and contact details |
| | Shipment number |
| | Number of packages within the Shipment |
| | Size of each package within the Shipment |
| | Contents of products within each package |
| | of the Shipment |
| | Additional Requirements not provided in step 3 |
| | The name/scat code of the Carriers and the carriers |
| | shipment tracking number |
| | The Carrier estimated date of delivery |
| | (ETD) to LC site |
| 9 | LC operator receives the second Online shipment record |
| | and updates their cloud-based shipment record accordingly. |
| 10 | The Online retailer releases (tenders) the |
| | shipment from their Distribution |
| | Center or point of fulfillment to the assigned carrier. |
| 11 | LC operator sends the second electronic note to the |
| | Customer with the high-level details of the shipment, |
| | carrier information, ETD, and any additional |
| | requirements of the shipment. |
| 12 | Customer has access to the online purchase and |
| | shipment information at this point via LC webpage and app; |
| | direct information or pass-through information |
| | from 3rd party websites as required. |
| 13 | The Carrier with the Customer's shipment arrives at |
| | the assigned Logistics Center. |
| 14 | The Carrier engages the Carrier access Kiosk next to |
| | the Carrier access man-doors. The Carrier fellows the LC |
| | security protocols via the Kiosk instructions to gain entry |
| | into the LC carrier access area of the Logistic Center. |
| | LC baseline system accepts security protocols and send |
| | message to the carrier access door locking mechanism |
| | to unlock the carrier access door or |
| | LC baseline system rejects security protocol and send |
| | message to carrier via the Kiosk that the carrier with the |
| | shipment was unknown and access will not be allowed. |
| 15 | Carrier and shipment information is accepted by the |
| | LC baseline technology and the Carrier access man-door |
| | is unlocked for Carrier entry. Carrier enters |
| | the Logistics Center. |
| 16 | Carrier entered the induction area and engages the |
| | provided Kiosk near the LC induction machine. The Carrier |
| | follows the protocols and instructions for |
| | tendering shipment packages into LC storage unit |
| | via the induction machine. |
| 17 | Carrier obtains an induction sheet (metal storage |
| | medium and places the first shipment package on |
| | to the induction sheet. The carrier then places the |
| | induction sheet including the package into the |
| | induction machine. |
| 18 | The induction machine performs the following functions: |
| | Finds and scans the shipment tracking barcode |
| | Calculates the package weight |
| | Determine length, width and height of the package |
| | Photographs (scans) 5 sides of the package |
| | for integrity issues |
| | Takes 5-sided images of the package |
| | All the above information, date and images are posted |
| | to the LC operator's records. |
| 19 | The induction machine communicating with the LC |
| | indicators and controls: |
| | Ready to move the induction sheet and package |
| | to a robot for put-a-way |
| | Or has identified a problem and the package is |
| | being rejected and return to the Carrier representative |
| 20 | The induction machine communicates with the LC |
| | operator baseline technology and passes an electronic message |
| | that the package is ready for put-a-way. The |
| | LC operator technology determines the best storage |
| | location within the shelving system for the shipment |
| | package. The LC operator system electronically |
| | communicates with the Robotic control system to |
| | assign a Robot to pick-up the induction sheet with the package |
| | and move to the direct shelving location. |
| 21 | The assigned Robot electronically communicates with |
| | the Robot control system when it picks up the induction |
| | sheet and package, transports to the assigned |
| | shelving location, and places the induction sheet and |
| | package in the said location. |
| 22 | After the put-a-way activity, the Robot waits for the next |
| | assignment from Robotic control system: |
| | Robot get next assignment or |
| | Robot move to assign waiting location |
| 23 | The Carrier representative via instructions from the Kiosk: |
| | Continues to place package(s) that are known |
| | to the LC system baseline technology shipment |
| | manifest e into the induction machine |
| | (one at a time) or |
| | Let the LC system know that he/she is complete |
| | with injecting shipment package(s). |
| 24 | The Carrier via the Kiosk lets the LC system know they |
| | have completed their activities with the induction of |
| | shipment package(s). The Kiosk provides last |
| | instructions to the Carrier and allows a specific time |
| | to the carrier representative to exit the Logistic Center |
| | before relocking the Carrier man-door. |
| 25 | The Carrier representative exits the Logistic Center and |
| | the Kiosk communicates with the LC system technology |
| | to send a message to the carrier |
| | man-door electronic locking mechanism to relock. |
| 26 | The Carrier personnel door electronic locking mechanism |
| | relocks and sends message to the LC system that: |
| | The door is closed and locked or |
| | It was expecting the door to be close and locked |
| | but there was a failure |
| 27 | The Logistic Center carrier door electronic locking |
| | mechanism sends back message to LC system that the |
| | door is closed and lock is activated properly. |
| 28 | LC system sends its third message to the customer |
| | that an expected shipment and corresponding packages |
| | have been received at the Logistics Center and |
| | are ready for pick-up or delivery at the |
| | customer's convenience, and outlines |
| | the free time storage allowance for the shipment. |
| 29 | Customer receives LC third message on their smart |
| | devices. Using the LC app or webpage, the customer |
| | at their convenience makes one of the following |
| | decisions regards obtaining their shipment: |
| | Self-pick-up (walk-up or drive-up) |
| | Pick-up via their pre-approved friend and family list |
| | Crowdshare type direct to home delivery |
| | Surface based transportation robots (when available) |
| | Air Drone service (when available) |
| | Autonomous Vehicle (when available) |
| | Hold the shipment in paid storage (if storages |
| | pass the free time allowance) |
| 30 | Customer decides to do a self-pick-up |
| 31 | Before heading to the Logistics Center, and as |
| | pre-set up as an LC member, the Customer turns on his/her |
| | GPS on their smart device (cell-phone). The |
| | LC system begins to track the Customer to the LC location. |
| 32 | The LC system communicating with the Robotic |
| | Control system dispatches a Robot to move the |
| | customer's shipment package to a “hot location” near the |
| | disbursement window to speed up the process time at |
| | the Logistic Center for the customer. |
| 33 | The LC system continues to track customer via GPS |
| | inbound to the Logistic Center. When close to the hub, |
| | the LC system provides notification to |
| | Customers smart device on suggested Kiosk |
| | and disbursement window to use |
| | at the Logistic Center that is closest to the “hot location”. |
| 34 | Customer arrives at the Logistic Center and goes |
| | to the suggested Kiosk and disbursement window. |
| | The customer engages the Kiosk using his/her smart |
| | device via the LC app. |
| 35 | The Kiosk interfacing with the LC system |
| | validates the inormation from the |
| | customers smart device and determines; |
| | If the information is valid and a shipment |
| | package is available for pick-up or |
| | The information is not valid and there is not a |
| | shipment package available for pick-up |
| 36 | The LC system finds the shipment records, |
| | determines it is valid, and communicates with the Robotic |
| | Control System to dispatch a Robot to obtain the shipment |
| | package and deliver to assigned disbursement window. |
| 37 | The assigned Robot travels to the shelving locations |
| | within the Logistic Center where the customer's shipment |
| | package is located, picks up the shipment |
| | package on the induction sheet, and travels to the |
| | assigned disbursement window. |
| 38 | The customer at the Kiosk is given step by step |
| | information on the process and how the process for obtaining |
| | their shipment package is progressing, include a |
| | live video of the Robot pick, and delivering their |
| | shipment to the disbursement window. |
| 39 | Robot places the customer's shipment package on the |
| | induction sheet into the disbursement window. |
| 40 | The Robot communicates with the Robot Control |
| | System to send a message that the task is complete, and |
| | this information is passed to the LC system and |
| | on to the disbursement window and door control |
| | systems. The disbursement window control system moves |
| | the disbursement truck into place and when |
| | complete to robot access position. |
| 41 | The LC system passes a task to the disbursement |
| | windows control systems and the locking mechanism to |
| | unlock and sends a message to the Kiosk |
| | interfacing with the customer that their |
| | shipment package is ready and it is time |
| | to open the disbursement window. |
| 42 | The Customer opens the disbursement window |
| | and takes their shipment package then closes the |
| | disbursement window and closes out the process |
| | using the LC system kiosk |
| 43 | The LC system sends a message to the disbursement |
| | windows control system and its locking mechanism |
| | to relock. The disbursement window locking mechanism |
| | sends back a message to the LC system LC system that: |
| | It has successfully relocked or |
| | It has not successfully relocked and there is a failure |
| 44 | The Disbursement window locking mechanism sends |
| | back a message to the LC that it has successfully |
| | relocked. Then the LC system communicates with |
| | the disbursement control system and sends a task to |
| | tray stacker/unstacker to remove the induction tray |
| | (bakers' sheet) from the disbursement window and |
| | place in a holding position. |
| 45 | The LC system baseline technology sends a communication |
| | to the Customer App and e-mail address |
| | thanking them for using LC system and asking for their |
| | input to a survey |

Although preferred embodiments of the invention have been described using specific terms, devices, and methods, such description is for illustrative purposes only. The words used are words of description rather than of limitation. It is to be understood that changes and variations may be made by those of ordinary skill in the art without departing from the spirit or the scope of the present invention. In addition, it should be understood that aspects of the various embodiments may be interchanged, both in whole, or in part. Therefore, the spirit and scope of the invention should not be limited to the description of the preferred versions contained therein.

That which is claimed:

1. A method of facilitating the delivery of a package to a customer comprising the steps of:
providing a package receiving and holding facility;
providing secure access to a commercial shipper of customer packaging to the facility;
providing an intake control system wherein a customer package from the commercial facility is deposited, verified and stored, the storage step further including the step of a robotic transfer to a first storage location based on at least one of package size, pattern weight, package shape, and temperature storage needs;
following the storage step, providing an electronic notification to a customer that a package is available for pick up at the facility;
providing the customer with a plurality of pick up options including, but not limited to, self-pick up, designated friend/family member, courier service delivery, delivery by air drone, delivery by surface robot, delivery by autonomous vehicle or delivery by a designated authorized agent who may retrieve and deliver the package.

2. A process of delivering a package to a customer comprising the steps of:
providing a customer at a point of purchase a delivery option for a delivery;
verifying customer information and customer packaging requirements that an address and package content may be processed via a Logistics Center;
accepting shipment from a retailer to a Logistic Center;
accepting receipt of the package at a Logistic Center, the acceptance process further including accessing a secure Logistic Center building by a carrier deliverer using a security protocol and further including granting access to carrier personnel to the Logistic Center, the access including interaction with an induction apparatus;
placing the package on an induction sheet associated with the induction apparatus, the induction apparatus providing the functions of scanning the package bar code, measuring the package weight, determining dimensions of length, width, height, and shape of the package, taking visual images of five sides of the package to determine package integrity, and storing the package information obtained within a database of the Logistics Center operator;
moving the induction sheet and package placed upon the induction sheet to a storage location within a Logistic Center;
delivering an electronic communication from the Logistics Center to the customer that the package is available for delivery;
prompting the customer to select a package delivery option selected from the group consisting of self pick up, pick up via an approved individual on a list of approved individuals; home delivery via a third party; surface transportation robot, air drone service, autonomous vehicle, and
providing access to the packaging based upon the delivery option requested by the customer.

3. The process according to claim 2 wherein when the package pick-up option includes a manual, in person pick-up, an individual retrieving the package is prompted to activate a GPS device;
tracking the GPS device, dispatching the package to a designated retrieval location when the GPS indicates the agent has arrived at the Logistic Center;
directing the individual to a specific kiosk and a distribution window;
validating that the package is within the disbursement window, the package being dispatched to the disbursement window via a robotic retrieval process.

4. The process according to claim 2 wherein the step of moving the induction sheet and package further includes using an automated mechanical handler to position the induction sheet within a slotted receiving area, the slotted receiving area adapted for retaining a plurality of induction sheets.

5. The process according to claim 2 wherein said steps of accepting receipt of the package, granting access to carrier personnel, placing the package on induction sheet, and providing access to the package are all monitored by a remote-control center.

6. The process according to claim 2 wherein following selection by customer of a delivery option for a delivery, the customer can thereafter change a delivery option upon receipt of the package by the Logistic Center.

7. The process according to claim 2 wherein a customer may authenticate a third-party individual for retrieving a package from the Logistic Center.

8. The process according to claim 3 wherein following the validation step, additional steps include:
providing access to the customer to the package;
verifying that the package has been retrieved, and
thereafter, locking the disbursement window.

9. The process according to claim 8 wherein absent verification of the locking step of the disbursement window, no additional packages will be delivered to the disbursement window.

10. The process according to claim 1 wherein following the step of the customer retrieving a package, a customer may thereafter return a package to a retailer by the additional steps of:
obtaining a return authorization from a retailer;
placing a return label on the package;
accessing a Kiosk at a receiving and holding facility, the Kiosk promoting the customer for information to validate the return authorization credentials;
depositing the package within a designated access door of the receiving and holding facility;
storing the package for pick up by a commercial carrier.
